(19) United States
(12) Patent Application Publication
(10) Pub. No.: US 2016/0135041 A1
(43) Pub. Date: May 12, 2016

(54) WI-FI PRIVACY IN A WIRELESS STATION USING MEDIA ACCESS CONTROL ADDRESS RANDOMIZATION

(71) Applicant: QUALCOMM Incorporated, San Diego, CA (US)

(72) Inventors: Soo Bum Lee, San Diego, CA (US); Jouni Kalevi Malinen, Tuusula (FI); George Cherian, San Diego, CA (US)

(21) Appl. No.: 14/926,616

(22) Filed: Oct. 29, 2015

Related U.S. Application Data
(60) Provisional application No. 62/077,769, filed on Nov. 10, 2014.

(51) Int. Cl. H04W 12/02; H04L 29/06; H04L 12/741

(52) U.S. Cl. CPC H04W 12/02; H04L 45/745; H04L 69/22; H04W 84/12

(57) ABSTRACT

Methods, systems, apparatuses, and devices are described for wireless station privacy using media access control (MAC) address randomization. The wireless station may identify a MAC address for use with over-the-air transmissions and a persistent MAC address for backend communications. The wireless station may communicate the OTA MAC address and the persistent MAC address to an access point. The wireless station and the access point may exchange data frames and perform MAC replacement techniques to map the OTA MAC address to the persistent MAC address. The persistent MAC address may provide for data routing, mobility management, etc., whereas the OTA MAC address may provide for privacy for the wireless transmissions.

### CROSS REFERENCES

The present Application for Patent claims priority to U.S. Provisional Patent Application No. 62/077,769 by Lee et al., entitled “Wi-Fi Privacy in a Wireless Station Using Media Access Control Address Randomization,” filed Nov. 10, 2014, assigned to the assignee hereof, and expressly incorporated by reference herein.

### BACKGROUND

1. Field of the Disclosure

The present disclosure, for example, relates to wireless communication systems, and more particularly to privacy in a wireless station using media access control randomization.

2. Description of Related Art

Wireless communication systems are widely deployed to provide various types of communication content such as voice, video, packet data, messaging, broadcast, and so on. These systems may be multiple-access systems capable of supporting communications with multiple users by sharing the available system resources (e.g., time, frequency, and power). A wireless network, for example a Wireless Local Area Network (WLAN), such as a Wi-Fi network (IEEE 802.11) may include an access point (AP) that may communicate with wireless stations (STAs) or mobile devices. The AP may be coupled to a network, such as the Internet, and enable a mobile device to communicate via the network (and/or communicate with other devices coupled to the access point).

Privacy issues relating to Wi-Fi networks are a concern for network providers and users alike. A STA wirelessly communicating with an AP may include its permanently assigned media access control (MAC) address in its frame transmissions for identification. The STA sending its MAC address, however, presents an opportunity to an observer to intercept the wireless transmissions, identify the STA's MAC address, and determine information otherwise considered private and personal. For example, an observer or attacker can track the mobility of the STA, identify the user of the STA (e.g., personally identifying information), perform traffic analysis (e.g., determine the activities of the user), etc.

Randomly selecting a MAC address for Wi-Fi communications, however, may introduce other difficulties. One concern is data routing to and from the STA. For example, an AP may not have a random MAC address of the STA and, therefore, may experience difficulty routing data through the network to the STA. Another concern relates to association, mobility, etc. For example, an authenticated and associated STA that changes its MAC address during a communication session may disrupt the association. Other concerns may include re-association and on-boarding (e.g., applications/systems that rely on the STA MAC address as part of authorization/access control).

### SUMMARY

The described features generally relate to various improved systems, methods, and/or apparatuses for wireless communications. Such systems, methods, and/or apparatuses may provide for media access control (MAC) address randomization in a wireless station to improve privacy and prevent an observer from snooping on the wireless station's communications. The techniques may include utilization of an over-the-air (OTA) MAC address and a persistent MAC address. For example, a station (STA) may determine the OTA MAC address that may be used for OTA wireless communications between the STA and an access point (AP). The OTA MAC address may provide for privacy or anonymity of the STA and its associated user. The STA may also determine a persistent MAC address that may be used for backend communications via the AP, e.g., for traffic routing across network resources. The persistent MAC address may be used for inter-operability with backend legacy systems. The STA may communicate the OTA MAC address and the persistent MAC address to the AP during authentication and/or association via a secure channel. For example, the OTA MAC address and the persistent MAC address may be communicated to the AP after being encrypted using a shared key established during the authentication and/or association process. The STA and AP may wirelessly exchange data frames that include the OTA MAC address and perform MAC replacement to identify the associated persistent MAC address of the STA. Accordingly, the persistent MAC address may provide for data source/destination routing functions.

In some aspects, the AP may receive the OTA MAC address and the persistent MAC address, or information indicative of such addresses, from the STA. The AP may perform MAC replacement for data frames received from and/or transmitted to the STA. For data frames destined for the STA, the AP may replace the persistent MAC address with the OTA MAC address before transmitting the data frames to the STA. For data frames received from the STA, the AP may replace the OTA MAC address in the data frames with the persistent MAC address and route the data frames to its destination with the persistent MAC address.

In a first set of illustrative examples, a method for wireless communication at a wireless station is provided. The method may include determining a first media access control (MAC) address associated with over-the-air (OTA) communications between the wireless station and an access point during a communication session, determining a second MAC address associated with backend communications via the access point during the communication session, and communicating the first MAC address and the second MAC address to the access point via a secure channel.

In some aspects, the method may include generating a random MAC address, the random MAC address comprising a third MAC address, wherein the third MAC address is used as a source address prior to communicating the first MAC address and the second MAC address to the access point via the secure channel. In some aspects, the method may include generating a random MAC address, the random MAC address comprising the first MAC address, and transmitting at least one message to the access point comprising the random MAC address via the secure channel. The method may include performing, with the access point, a security association process to establish the secure channel. The method may include transmitting information indicative of the first MAC address and the second MAC address to the access point in a message 4 of the security association process, wherein the security association process is a 4-way handshake procedure. The first MAC address and the second MAC address may be encrypted. The transmission of the information indicative of the first MAC address and the second MAC address to the access point may be made in a message 2 of the security association process in some examples. The method may include transmitting information indicative of the first MAC address and the second MAC address to the access point in a message 1 of the security association process, wherein the security association process is a 2-way handshake procedure.

In some aspects, the method may include receiving a data frame from the access point during the communication session, the data frame comprising information indicative of the first MAC address, replacing the first MAC address in the data frame with the second MAC address, and decoding the data frame based at least in part on the second MAC address. In some aspects, the method may include identifying a data frame to be transmitted to the access point during the communication session, the data frame comprising information indicative of the second MAC address, replacing the second MAC address in the data frame with the first MAC address, and transmitting the data frame to the access point using the first MAC address as a source address.

In some aspects, the method may include receiving a data frame from the access point during the communication session, the data frame comprising a MAC frame having the second MAC address as a destination address being encapsulated with a MAC frame header having the first MAC address as a destination address, removing the MAC frame encapsulating the second MAC address, and decoding the data frame based at least in part on the second MAC address.

In some aspects, the method may include identifying a data frame to be transmitted to the access point during the communication session, encapsulating a MAC frame having the second MAC address as a destination address with a MAC frame header having the first MAC address as a destination address, and transmitting the data frame to the access point, the data frame comprising the encapsulated MAC frame. The second MAC address may be valid for the communication session. The method may include deriving the second MAC address based at least in part on a pairwise master key known by the wireless station and the access point. The first MAC address may be valid for the communication session.

In some aspects, the method may include changing the first MAC address during the communication session based at least in part on a pairwise master key known by both the wireless station and the access point. The second MAC address may be a permanent MAC address of the wireless station.

In a second set of illustrative examples, an apparatus for wireless communication is provided. The apparatus may include a processor, memory in electronic communication with the processor, and instructions being stored in the memory. The instructions may be executable by the processor to determine a first MAC address associated with OTA communications between a wireless station and an access point during a communication session, determine a second MAC address associated with backend communications via the access point during the communication session, and communicate the first MAC address and the second MAC address to the access point via a secure channel.

In some aspects, the apparatus may include instructions executable by the processor to generate a random MAC address, the random MAC address comprising a third MAC address, wherein the third MAC address is used as a source address prior to communicating the first MAC address and the second MAC address to the access point via the secure channel. In some aspects, the apparatus may include instructions executable by the processor to generate a random MAC address, the random MAC address comprising the first MAC address, and transmit at least one message to the access point comprising the random MAC address via the secure channel. The apparatus may include instructions executable by the processor to perform, with the access point, a security association process to establish the secure channel. The apparatus may include instructions executable by the processor to transmit information indicative of the first MAC address and the second MAC address to the access point in a message 4 of the security association process, wherein the security association process is a 4-way handshake procedure. The first MAC address and the second MAC address may be encrypted. The transmission of the information indicative of the first MAC address and the second MAC address to the access point may be made in a message 2 of the security association process in some examples.

In some aspects, the apparatus may include instructions executable by the processor to transmit information indicative of the first MAC address and the second MAC address to the access point in a message 1 of the security association process, wherein the security association process is a 2-way handshake procedure. The apparatus may include instructions executable by the processor to receive a data frame from the access point during the communication session, the data frame comprising information indicative of the first MAC address, replace the first MAC address in the data frame with the second MAC address, and decode the data frame based at least in part on the second MAC address.

In some aspects, the apparatus may include instructions executable by the processor to identify a data frame to be transmitted to the access point during the communication session, the data frame comprising information indicative of the second MAC address, replace the second MAC address in the data frame with the first MAC address, and transmit the data frame to the access point using the first MAC address as a source address. The apparatus may include instructions executable by the processor to receive a data frame from the access point during the communication session, the data frame comprising a MAC frame having the second MAC address as a destination address being encapsulated with a MAC frame header having the first MAC address as a destination address, remove the MAC frame encapsulating the second MAC address, and decode the data frame based at least in part on the second MAC address.

In some aspects, the apparatus may include instructions executable by the processor to identify a data frame to be transmitted to the access point during the communication session, encapsulate a MAC frame having the second MAC address as a destination address with a MAC frame header having the first MAC address as a destination address, and transmit the data frame to the access point, the data frame comprising the encapsulated MAC frame. The second MAC address may be valid for the communication session.

In some aspects, the apparatus may include instructions executable by the processor to derive the second MAC address based at least in part on a pairwise master key known by the wireless station and the access point. The first MAC address may be valid for the communication session. The apparatus may include instructions executable by the processor to change the first MAC address during the communication session based at least in part on a pairwise master key known by both the wireless station and the access point. The second MAC address may be a permanent MAC address of the wireless station.

In a third set of illustrative examples, a method for wireless communication at an access point is provided. The method may include receiving, from a wireless station, information indicative of a first MAC address associated with OTA communications and a second MAC address associated with backend communications for the wireless station, exchanging a data frame between the access point and the wireless station, the data frame comprising the first MAC address, and mapping, for the data frame, the first MAC address to the second MAC address of the wireless station to process the data frame.

In some aspects, the method may include performing backend communications for the data frame based at least in part on the second MAC address. In some aspects, the method may include constructing a look-up table to map the first MAC address to the second MAC address or map the second MAC address to the first MAC address. Mapping the first MAC address to the second MAC address may include referencing a look-up table to identify the second MAC address that corresponds to the first MAC address, and replacing the first MAC address with the second MAC address in the data frame. Mapping the first MAC address to the second MAC address may include, referencing a look-up table to identify the second MAC address that corresponds to the first MAC address, removing a MAC frame header with a destination address of the first MAC address from the data frame to reveal a MAC frame with a destination address of the second MAC address.

In a fourth set of illustrative examples, an apparatus for wireless communication is provided. The apparatus may include a processor, memory in electronic communication with the processor, and instructions being stored in the memory. The instructions may be executable by the processor to receive, from a wireless station, information indicative of a first MAC address associated with OTA communications and a second MAC address associated with backend communications for the wireless station, exchange a data frame between an access point and the wireless station, the data frame comprising the first MAC address, and map, for the data frame, the first MAC address to the second MAC address of the wireless station to process the data frame.

In some aspects, the apparatus may include instructions executable by the processor to perform backend communications for the data frame based at least in part on the second MAC address. In some aspects, the apparatus may include instructions executable by the processor to construct a look-up table to map the first MAC address to the second MAC address or map the second MAC address to the first MAC address. The instructions executable to map the first MAC address to the second MAC address may be further executable to reference a look-up table to identify the second MAC address that corresponds to the first MAC address, and replace the first MAC address with the second MAC address in the data frame. The instructions executable to map the first MAC address to the second MAC address may be further executable to reference a look-up table to identify the second MAC address that corresponds to the first MAC address, remove a MAC frame header with a destination address of the first MAC address from the data frame to reveal a MAC frame with a destination address of the second MAC address.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communication system, in accordance with various aspects of the present disclosure;

FIG. 2 shows a block diagram of a device for use in wireless communication, in accordance with various aspects of the present disclosure;

FIG. 3 shows a block diagram of a device for use in wireless communication, in accordance with various aspects of the present disclosure;

FIG. 4 shows a block diagram of a wireless communication system, in accordance with various aspects of the present disclosure;

FIG. 5 shows a block diagram of an apparatus for use in wireless communication, in accordance with various aspects of the present disclosure;

FIG. 6 shows a block diagram of an apparatus for use in wireless communication, in accordance with various aspects of the present disclosure;

FIG. 7 shows a block diagram of a wireless station for use in wireless communication, in accordance with various aspects of the present disclosure;

FIG. 8 shows a swim lane diagram illustrating aspects of wireless communication, in accordance with various aspects of the present disclosure;

FIG. 9 shows a swim lane diagram illustrating aspects of wireless communication, in accordance with various aspects of the present disclosure;

FIG. 10 shows a swim lane diagram illustrating aspects of wireless communication, in accordance with various aspects of the present disclosure;

FIG. 11 shows a flow chart illustrating an example of a method for wireless communication, in accordance with various aspects of the present disclosure;

FIG. 12 shows a flow chart illustrating an example of a method for wireless communication, in accordance with various aspects of the present disclosure; and

FIG. 13 shows a flow chart illustrating an example of a method for wireless communication, in accordance with various aspects of the present disclosure.

### DETAILED DESCRIPTION

When a wireless station (STA) is associated with an access point (AP), the data frames may include information indicative of a permanent media access control (MAC) address of the wireless station. The MAC address may be used for association functions, e.g., key derivation functions, etc. The MAC address may also be used for routing functions to ensure data frames destined for the wireless station are received and decoded at a correct wireless station. Accordingly, random changes to the MAC address may introduce challenges from the wireless station, the access point, or the legacy network perspectives. Also, privacy may become a concern because an eavesdropper may intercept the wireless transmissions between the wireless station and the access point and determine the MAC address of the wireless station. Based on the MAC address, the interceptor may determine various information of the wireless station or the user of the wireless station, e.g., personally identifiable information, network traffic patterns, location and mobility, etc.

Aspects of the present disclosure relate to privacy in a wireless station using various techniques to provide MAC address randomization but yet support legacy network functions. In some aspects, the MAC address randomization may include generating and/or using a random MAC address for pre-association messages (e.g., probe request and probe response frames) during a pre-association process prior to a security association process between a wireless station and an access point (i.e., prior to establishing a secure channel between the wireless station and the access point). In some aspects, the MAC address randomization may include generating and/or using a random MAC address for authentication and association messages during a security association process between a wireless station and an access point. For a pre-association process, a random MAC address may be generated and/or used for an exchange of pre-association messages, such as an exchange of a probe request frame and a probe response frame between a wireless station and an access point. Once an authentication and association process has been completed, another random MAC address may be generated and/or used for an over-the-air (OTA) MAC address to protect privacy of the over-the-air communications between the wireless station and the access point. The OTA MAC address may be same as the random MAC address used for pre-association message exchanges.

In some aspects, the wireless station may use MAC address randomization by determining or otherwise identifying two MAC address for communicating with an access point. The first MAC address may be used for over-the-air communications between the wireless station and the access point. The second MAC address may be a persistent MAC address of the wireless station used for backend communications to support legacy network functions, e.g., data routing, authentication functions for on-board applications, etc. The wireless station may communicate both MAC addresses to the access point over a secure channel during a security association procedure, e.g., a 2-way handshake procedure, a 4-way handshake procedure, and the like. Accordingly, the wireless station and the access point may exchange data frames that include the first OTA MAC address and perform MAC replacement functions to associate the second persistent MAC address with the data frames. The second persistent MAC address may then be used for data routing functions.

Correspondingly, the access point may support wireless station privacy using the OTA and persistent MAC addresses. For example, the access point may receive the OTA and persistent MAC addresses from the wireless station and, during data frame communications, perform MAC replacement functions to replace or otherwise reveal the persistent MAC address associated with the OTA MAC address. An eavesdropper that snoops the OTA MAC address may not be able to determine the associated persistent MAC address and, therefore, may not be able to ascertain the private information of the wireless station or its user. In some aspects, the OTA MAC address may be changed according to a predetermined schedule during a communication session (e.g., during an extended association period) to further improve privacy and deter eavesdropping.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

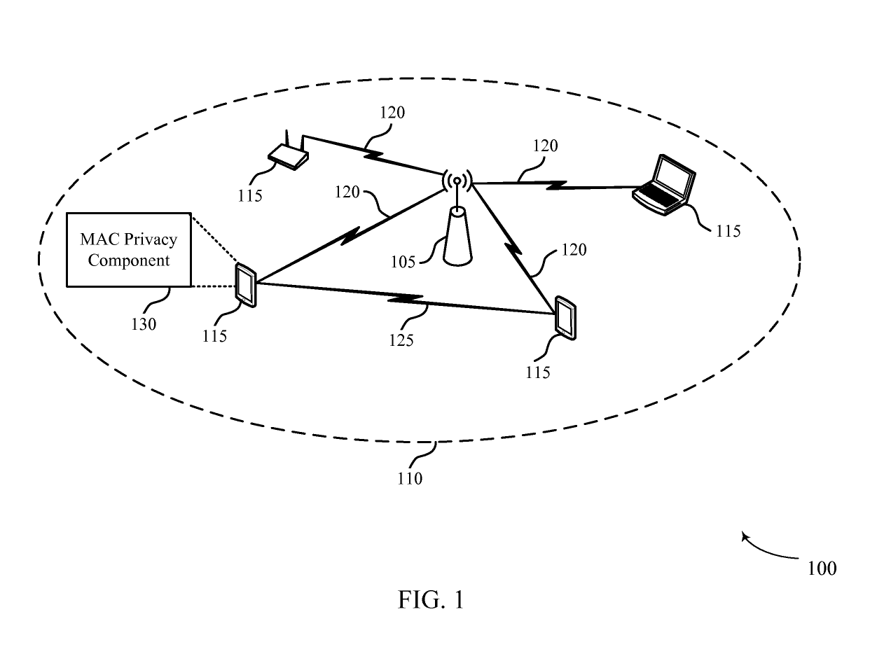

Referring first to FIG. 1, a block diagram illustrates an example of a WLAN network 100 such as, e.g., a network implementing at least one of the IEEE 802.11 family of standards. The WLAN network 100 may include an access point (AP) 105 and wireless devices or stations (STAs) 115, such as mobile stations, personal digital assistants (PDAs), other handheld devices, netbooks, notebook computers, tablet computers, laptops, display devices (e.g., TVs, computer monitors, etc.), printers, etc. While only one AP 105 is illustrated, the WLAN network 100 may have multiple APs 105. Each of the wireless stations 115, which may also be referred to as mobile stations (MSs), mobile devices, access terminals (ATs), user equipment (UE), subscriber stations (SSs), or subscriber units, may associate and communicate with an AP 105 via a communication link 120. Each AP 105 has a geographic coverage area 110 such that wireless stations 115 within that area can communicate with the AP 105. The wireless stations 115 may be dispersed throughout the geographic coverage area 110. Each wireless station 115 may be stationary or mobile.

Although not shown in FIG. 1, a wireless station 115 can be covered by more than one AP 105 and can therefore associate with APs 105 at different times. A single AP 105 and an associated set of stations may be referred to as a basic service set (BSS). An extended service set (ESS) is a set of connected BSSs. A distribution system (DS) (not shown) is used to connect APs 105 in an extended service set. A geographic coverage area 110 for an access point 105 may be divided into sectors making up only a portion of the coverage area (not shown). The WLAN network 100 may include access points 105 of different types (e.g., metropolitan area, home network, etc.), with varying sizes of coverage areas and overlapping coverage areas for different technologies. Although not shown, other wireless devices can communicate with the AP 105.

While the wireless stations 115 may communicate with each other through the AP 105 using communication links 120, each wireless station 115 may also communicate directly with other wireless stations 115 via a direct wireless link 125. Two or more wireless stations 115 may communicate via a direct wireless link 125 when both wireless stations 115 are in the AP geographic coverage area 110 or when one or neither wireless station 115 is within the AP geographic coverage area 110 (not shown). Examples of direct wireless links 125 may include Wi-Fi Direct connections, connections established by using a Wi-Fi Tunneled Direct Link Setup (TDLS) link, and other Peer-to-Peer (P2P) group connections. The wireless stations 115 in these examples may communicate according to the WLAN radio and baseband protocol including physical and MAC layers from IEEE 802.11 standard, and its various versions including, but not limited to, 802.11b, 802.11g, 802.11a, 802.11n, 802.11ac, 802.11ad, 802.11ah, etc. In other implementations, other P2P connections and/or ad hoc networks may be implemented within WLAN network 100.

Wireless stations 115 may include a MAC privacy component 130 that manages aspects of privacy for wireless communications between the wireless station 115 and the AP 105. The wireless stations 115 may support communication techniques that utilize one MAC address for OTA communications (e.g., the wireless transmissions via links 120) and a second persistent MAC address for legacy network functions. The MAC privacy component 130 may determine the OTA MAC address and the persistent MAC address and communicate information indicative of both MAC addresses to the AP 105 via a secure channel. The AP 105 may receive the information indicative of the two MAC addresses for the wireless station 115 and support MAC address randomization for privacy functions. Accordingly, the wireless station 115 and the AP 105 may exchange data frames over links 120 where the data frames include the OTA MAC address. The wireless station 115 and the AP 105 may determine the persistent MAC address associated with the OTA MAC address in the data frame and perform MAC replacement to support routing functions, for example.

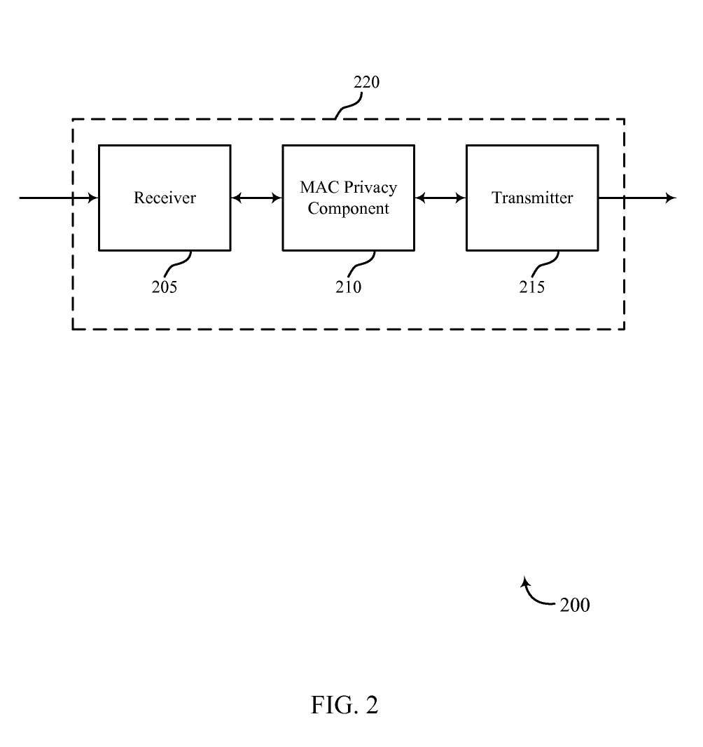

FIG. 2 shows a block diagram 200 of an apparatus 220 for use in a wireless station for wireless communication, in accordance with various aspects of the present disclosure. In some examples, the apparatus 220 may be an example of aspects of the wireless stations 115 described with reference to FIG. 1. The apparatus 220 may also be or include a processor (not shown). The apparatus 220 may include a receiver 205, a MAC privacy component 210, and/or a transmitter 215. Each of these components may be in communication with each other.

The apparatus 220, through the receiver 205, the MAC privacy component 210, and/or the transmitter 215, may perform functions described herein. For example, the apparatus 220 may manage aspects of MAC address randomization for the apparatus 220.

The components of the apparatus 220 may, individually or collectively, be implemented using application-specific integrated circuits (ASICs) adapted to perform some or all of the applicable functions in hardware. Alternatively, the functions may be performed by other processing units (or cores), on integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each component may also be implemented, in whole or in part, with instructions embodied in a memory, formatted to be executed by general or application-specific processors.

The receiver 205 may receive information such as packets, user data, and/or control information associated with various information channels (e.g., control channels, data channels, etc.). The receiver 205 may receive signals, messages, and the like for MAC address randomization for privacy from an access point. The receiver 205 may receive signals, messages, and the like associated with privacy from the access point using MAC address randomization. Information may be passed on to the MAC privacy component 210, and to other components of the apparatus 220.

The MAC privacy component 210 may manage aspects of MAC address randomization for privacy for the apparatus 220. The MAC privacy component 210 may identify two MAC addresses for communications with an AP 105. For example, a first MAC address may be associated with OTA communications. The OTA MAC address may be randomly selected and/or change according to a periodic schedule. The second MAC address may be a persistent MAC address used to support legacy network functions, e.g., data frame routing, mobility management, etc. The MAC privacy component 210 may communicate information indicative of the OTA and persistent MAC addresses to an AP 105. When the apparatus 220 has information to communicate, the MAC privacy component 210 may replace the persistent MAC address with the OTA MAC address and transmit, via the transmitter 215, the data frame(s) using the OTA MAC address as a source address of the apparatus 220. An AP 105 may receive the data frame(s) with the OTA MAC address and identify the persistent MAC address associated with the apparatus 220. The AP 105 may forward the data frames to legacy network components using the legacy MAC address to ensure the apparatus 220, as the source of the data frames, is properly identified.

In some aspects, the MAC privacy component 210 may receive, via the receiver 205, data frames from the AP 105 that include the OTA MAC address of the apparatus 220. The MAC privacy component 210 may determine that the OTA MAC address is associated with the persistent MAC address of the apparatus 220 and therefore replace the OTA MAC address with the persistent MAC address for data decoding.

The transmitter 215 may transmit the signals received from other components of the apparatus 220. The transmitter 215 may transmit various signals, messages, etc., associated with MAC address randomization for privacy and/or data frame transmissions using the randomized MAC addresses. In some examples, the transmitter 215 may be collocated with the receiver 205 in a transceiver component. The transmitter 215 may include a single antenna, or it may include a plurality of antennas.

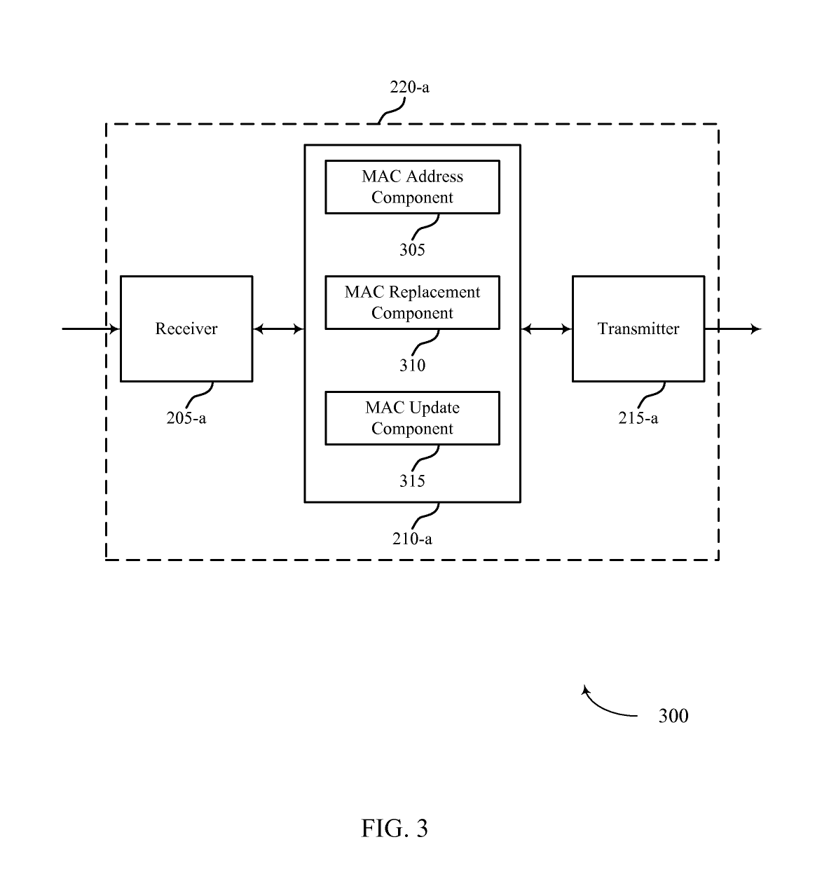

FIG. 3 shows a block diagram 300 of an apparatus 220-a that is used in a wireless station for wireless communication, in accordance with various examples. The apparatus 220-a may be an example of the aspects of a wireless station 115 described with reference to FIG. 1. It may also be an example of an apparatus 220 described with reference to FIG. 2. The apparatus 220-a may include a receiver 205-a, a MAC privacy component 210-a, and/or a transmitter 215-a, which may be examples of the corresponding components of apparatus 220. The apparatus 220-a may also include a processor (not shown). Each of these components may be in communication with each other. The MAC privacy component 210-a may include a MAC address component 305, a MAC replacement component 310, and a MAC update component 315. The receiver 205-a and the transmitter 215-a may perform the functions of the receiver 205 and the transmitter 215 of FIG. 2, respectively.

The MAC address component 305 may monitor, manage, or otherwise perform functions related to MAC address randomization for privacy of the apparatus 220-a. In some aspects, the MAC address component 305 may determine one MAC address to be used for OTA communications with an AP 105. The MAC address component 305 may determine a second MAC address that is a persistent MAC address and used for backend communications via the AP 105. The OTA MAC address and the persistent MAC address may be used for a communication session, e.g., for a particular exchange of data and/or for a period where the apparatus 220-a is associated with the AP 105. The MAC address component 305 may communicate information indicative of the OTA MAC address and the persistent MAC address to the AP 105 via a secure channel.

In some aspects, the MAC address component 305 may manage aspects of generating a random MAC address for pre-association activities and then determine the OTA and persistent MAC addresses for association/post-association activities. For example, the MAC address component 305 may determine or generate a random MAC address and transmit, via the transmitter 215-a, at least one message to the access point that includes the random MAC address as a source address during a pre-association process. The message may be a probe request message, for example, where the source address is the random MAC address.

The MAC address component 305, alone or in cooperation with other components of the apparatus 220-a, may perform a security association process to establish the secure channel with the AP 105 upon completion of an authentication and association with an access point. The security association process may be a 2-way handshake procedure, a 4-way handshake procedure, and the like. As part of the security association procedure, the MAC address component 305 may transmit information indicative of or associated with the first MAC address and the second MAC address to the AP. In some aspects, the first MAC address and the second MAC address may be encrypted. The information may be transmitted in a message 4 of the security association process, for a 4-way handshake procedure, in a message 2, or in a message 1 for a 2-way handshake procedure, for example. In some examples, the 2-way handshake procedure may include the association frame exchange according to the 802.11ai specification (e.g., the last two messages in a modified 4-way handshake procedure). In some aspects, the persistent MAC address may be the permanently assigned MAC address of the apparatus 220-a.

The MAC replacement component 310 may monitor, manage, or otherwise perform various functions related to OTA and persistent MAC address usage techniques for the apparatus 220-a. In some aspects, the MAC replacement component 310 may receive data frame(s) from the access point that include the OTA MAC address and replace the OTA MAC address with the persistent MAC address. The MAC replacement component 310 may, alone or in cooperation with other components of the apparatus 220-a, decode the data frames based on the persistent MAC address, e.g., use the persistent MAC address to confirm the apparatus 220-a is the correct destination address, perform cyclic redundancy checks based on the persistent MAC address, and the like.

In some aspects, the MAC replacement component 310 may correspondingly monitor, manage, or otherwise perform various functions related to transmission of data frames using the dual-MAC address schemes. For example, the MAC replacement component 310 may determine that data frames are to be transmitted to the access point and may replace the persistent MAC address of the apparatus 220-a with the OTA MAC address for transmitting the data frames. In some examples, the data frames may include a MAC frame having the persistent MAC address a source address of the apparatus 220-a. The MAC frame having the persistent MAC address may be encapsulated with a MAC frame header having the OTA MAC address as a source address. The MAC replacement component 310 may remove the MAC frame header encapsulating the persistent MAC address and decode the data frames based at least in part on the persistent MAC address. Correspondingly and for data frame transmissions, the MAC replacement component 310 may determine that there are data frames for transmission and encapsulate a MAC frame having the persistent MAC address as a source address with a MAC frame header having the OTA MAC address as a source address. The data frames may be transmitted to the access point including the encapsulated MAC frame.

The MAC update component 315 may manage, control, or otherwise perform various functions related to updating the OTA MAC address and/or the persistent MAC address for the apparatus 220-a. In some aspects, the persistent MAC address may be valid for the communication session, e.g., a period of time the apparatus 220-a is associated with an AP 105. In some aspects, the MAC update component 315 may derive the persistent MAC address based on a pairwise master key (PMK) known by the apparatus 220-a and the AP 105.

In some aspects, the OTA MAC address may be valid for a communication session and the MAC update component 315 may update or change the OTA MAC address during the communication session. For example, the MAC update component 315 may update or change the OTA MAC address based at least in part on a pairwise master key known by the apparatus 220-a and the AP 105.

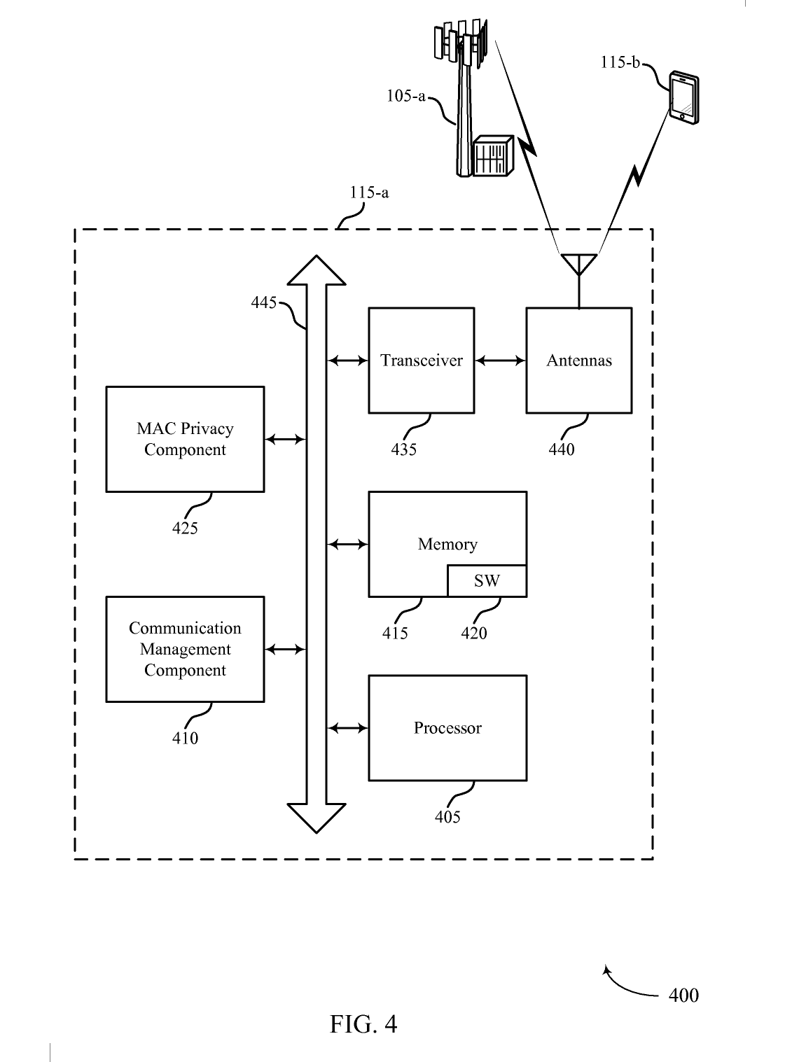

Turning to FIG. 4, a diagram 400 is shown that illustrates a wireless station 115-a for MAC address randomization for privacy that uses an OTA MAC address for wireless transmissions and a persistent MAC address for backend legacy network functions. The wireless station 115-a may have various other configurations and may be included or be part of a personal computer (e.g., laptop computer, netbook computer, tablet computer, etc.), a cellular telephone (e.g., a smartphone), a PDA, a digital video recorder (DVR), an internet appliance, a gaming console, an e-readers, etc. The wireless station 115-a may have an internal power supply (not shown), such as a small battery, to facilitate mobile operation. The wireless station 115-a may be an example of the wireless stations and/or apparatuses 220 of FIGS. 1-3.

The wireless station 115-a may include a processor 405, a memory 415, a transceiver 435, antennas 440, a MAC privacy component 425, and a communication management component 410. The MAC privacy component 425 may be an example of the MAC privacy component 210 of FIG. 2 or 3. Each of these components may be in communication with each other, directly or indirectly, over at least one bus 445.

The memory 415 may include random access memory (RAM) and read-only memory (ROM). The memory 415 may store computer-readable, computer-executable software (SW) code 420 containing instructions that, when executed, cause the processor 405 to perform various functions described herein for MAC address randomization for privacy. Alternatively, the software code 420 may not be directly executable by the processor 405 but cause the computer (e.g., when compiled and executed) to perform functions described herein.

The processor 405 may include an intelligent hardware device, e.g., a central processing unit (CPU), a microcontroller, an ASIC, etc. The processor 405 may process information received through the transceiver 435 and/or to be sent to the transceiver 435 for transmission through the antennas 440. The processor 405 may handle, alone or in connection with the MAC privacy component 425, various aspects for MAC address randomization for privacy that utilizes different MAC addresses for OTA transmissions and backend communications.

The transceiver 435 may communicate bi-directionally with APs 105 in FIG. 1 and/or with other wireless stations, mobile devices, and/or apparatuses 220 of FIGS. 2-3. The transceiver 435 may be implemented as at least one transmitter component and at least one separate receiver component. The transceiver 435 may include a modem to modulate packets and provide the modulated packets to the antennas 440 for transmission, and to demodulate packets received from the antennas 440. While the wireless station 115-a may include a single antenna, there may be aspects in which the wireless station 115-a may include multiple antennas 440.

According to the architecture of FIG. 4, the wireless station 115-a may further include a communication management component 410. The communication management component 410 may manage communications with various access points 105-a, wireless stations 115-b, etc. The communication management component 410 may be a component of the wireless station 115-a in communication with some or all of the other components of the wireless station 115-a over the at least one bus 445. Alternatively, functionality of the communication management component 410 may be implemented as a component of the transceiver 435, as a computer program product, and/or as at least one controller element of the processor 405.

The components of the wireless station 115-a may implement aspects discussed above with respect to FIGS. 1-3, and those aspects may not be repeated here for the sake of brevity.

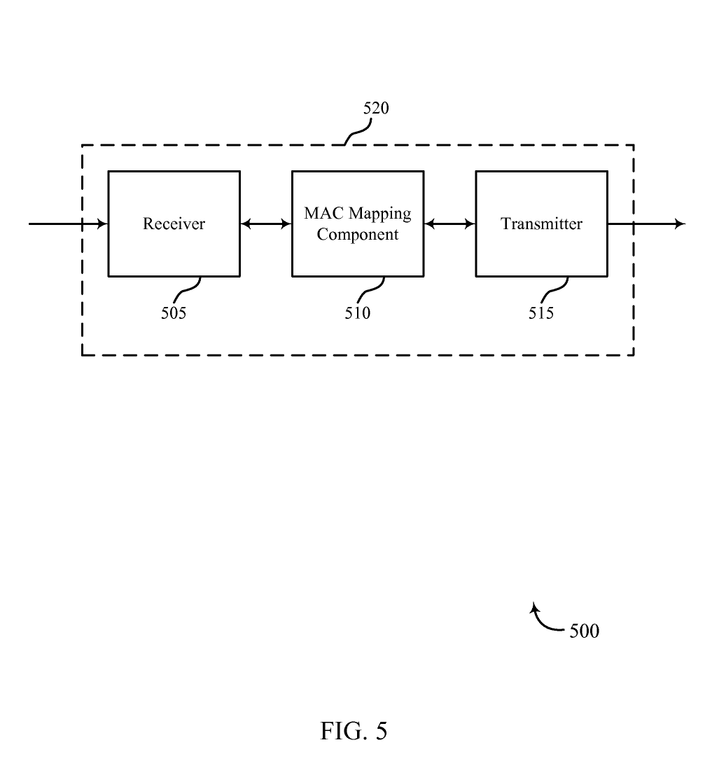

FIG. 5 shows a block diagram 500 of a device 520 for use in an AP/base station for wireless communications, in accordance with various aspects of the present disclosure. The device 520 may be an example of the aspects of an AP/base station 105 described with reference to FIGS. 1-4. The device 520 may include a receiver 505, a MAC mapping component 510, and/or a transmitter 515. The device 520 may also be or include a processor (not shown). Each of these components may be in communication with each other.

The device 520, through the receiver 505, the MAC mapping component 510, and/or the transmitter 515, may perform functions described herein. For example, the device 520 may support a wireless station using multiple MAC address for MAC address randomization to provide for privacy of wireless transmissions between the device 520 and the wireless station but yet supports legacy network functions such as routing.

The components of the device 520 may, individually or collectively, be implemented using ASICs adapted to perform some or all of the applicable functions in hardware. Alternatively, the functions may be performed by other processing units (or cores), on integrated circuits. In other examples, other types of integrated circuits may be used (e.g., Structured/Platform ASICs, FPGAs, and other Semi-Custom ICs), which may be programmed in any manner known in the art. The functions of each component may also be implemented, in whole or in part, with instructions embodied in a memory, formatted to be executed by general or application-specific processors.

The receiver 505 may receive information such as packets, user data, and/or control information associated with various information channels (e.g., control channels, data channels, etc.). The receiver 505 may receive an indication of an OTA MAC address and a persistent MAC address for the wireless station and receive data frames including the OTA MAC address and/or the persistent MAC address. Information may be passed on to the MAC mapping component 510, and to other components of the device 520.

The MAC mapping component 510 may monitor, manage, or otherwise perform functions relating to MAC address randomization for the device 520. In some aspects, the MAC mapping component 510 may receive the indication of an OTA MAC address and a persistent MAC address from the wireless station over a secure channel. In some aspects, the OTA MAC address and a persistent MAC address from the wireless station may be encrypted. The OTA MAC address may be used by the wireless station and the device 520 for wireless transmissions whereas the persistent MAC address may be used to support routing, authentication, association, and/or mobility, etc. The MAC mapping component 510 may receive the information associated with the OTA address and the persistent MAC address during a security association procedure, e.g., a 4-way handshake procedure, a 2-way handshake procedure, etc.

In some aspects, the MAC mapping component 510 may exchange, via the receiver 505 and/or the transmitter 515, data frame(s) with the wireless station that includes the OTA MAC address. The MAC mapping component 510 may map the OTA MAC address to the associated persistent MAC address for the wireless station using the look-up table, for example. Accordingly and for wireless station originated data, the MAC mapping component 510 may replace the OTA MAC address with the persistent MAC address and forward the data via legacy network entities using the persistent MAC address. In another example and for data transmitted to the wireless station, the MAC mapping component 510 may receive data from a legacy network entity that includes the persistent MAC address, map and replace the persistent MAC address to and with the OTA MAC address, and forward the data to the wireless station using the OTA MAC address.

The transmitter 515 may transmit the signals received from other components of the device 520. The transmitter 515 may transmit data frames employing MAC address randomization for privacy. In some examples, the transmitter 515 may be collocated with the receiver 505 in a transceiver.

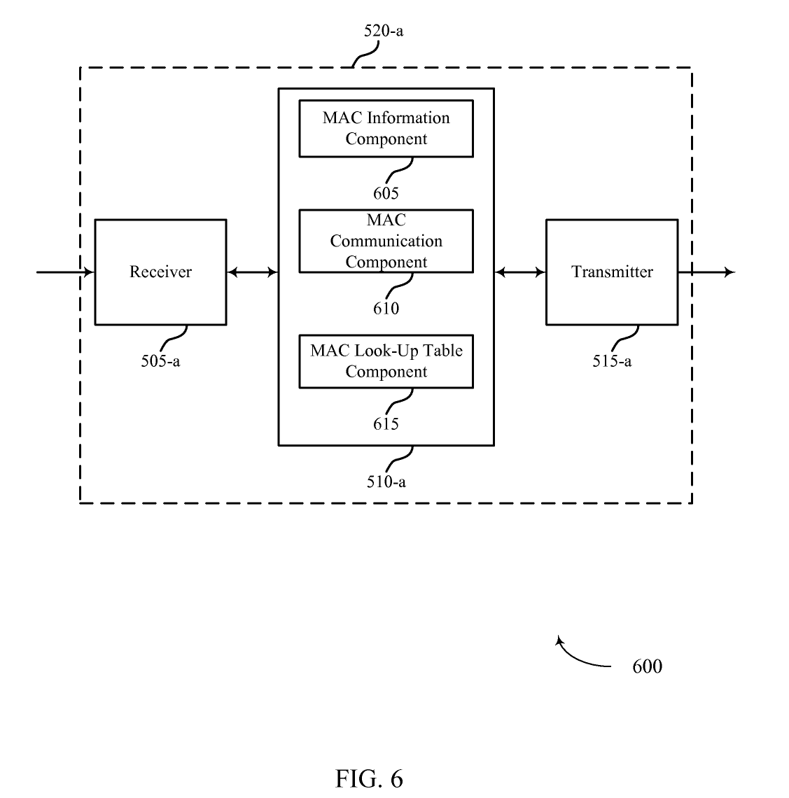

FIG. 6 shows a block diagram 600 of a device 520-a that is used in an AP/base station for wireless communications, in accordance with various examples. The device 520-a may be an example of the aspects of an AP/base station 105 described with reference to FIGS. 1-4. It may also be an example of a device 520 described with reference to FIG. 5. The device 520-a may include a receiver 505-a, a MAC mapping component 510-a, and/or a transmitter 515-a, which may be examples of the corresponding components of device 520 of FIG. 5. The device 520-a may also include a processor (not shown). Each of these components may be in communication with each other. The MAC mapping component 510-a may include a MAC information component 605, a MAC communication component 610, and a MAC look-up table component 615. The receiver 505-a and the transmitter 515-a may perform the functions of the receiver 505 and the transmitter 515 of FIG. 5, respectively.

The MAC information component 605 may manage, control, or otherwise perform various functions related to MAC address information for the device 520-a. In some aspects, the MAC information component 605 may receive an indication of an OTA MAC address and a persistent MAC address from a wireless station. The OTA MAC address may be associated with wireless transmissions between the device 520-a and the wireless station and may provide privacy protection from a wireless eavesdropper. The persistent MAC address may be associated with backend communications via the device 520-a, e.g., to provide data routing functions, to provide wireless station authentication and/or association for on-board applications, etc. The MAC information component 605 may receive the indication of the OTA and MAC addresses via messages exchanged during a security association process.

The MAC communication component 610 may manage, control, or otherwise perform various functions related to MAC address usage for the device 520-a. In some aspects, the MAC communication component 610 may perform MAC replacement functions for data frames exchanged with the wireless station. For example and for wireless station originated data, the MAC communication component 610 may receive a data frame including the OTA MAC address of the wireless station and replace the OTA MAC address with the associated persistent MAC address before forwarding the data frame to legacy network entities. As another example and for data addressed to the wireless station, the MAC communication component 610 may receive a data frame from a legacy network component and replace the persistent MAC address with the OTA MAC address for the wireless station before forwarding the data frame to the wireless station.

In some aspects, the MAC communication component 610 may manage aspects of encapsulation of the persistent MAC address. For example, the data frame may include a MAC frame header having the OTA MAC address as a destination address that encapsulates a MAC frame including the persistent MAC address as a destination address. The MAC communication component 610 may perform the encapsulation of the persistent MAC address for data being transmitted to the wireless station and may remove the encapsulation for data frames received from the wireless station.

The MAC look-up table component 615 may include information associated with OTA and persistent MAC addresses for wireless stations communicating with the device 520-a. For example, the MAC look-up table component 615 may, in cooperation with the MAC information component 605, the MAC communication component 610, and/or other components of the device 520-a, receive and store the OTA MAC address and the persistent MAC address for each wireless station in communication with the device 520-a and that supports MAC address randomization. The MAC look-up table component 615 may construct a look-up table to be used for mapping of the OTA MAC address to the persistent MAC address and/or mapping of the persistent MAC address to the OTA MAC address. Components of the device 520-a may access the MAC look-up table component 615 when replacing an OTA MAC address with a persistent MAC address for outbound data and replacing the persistent MAC address with the OTA MAC address for wireless station addressed data.

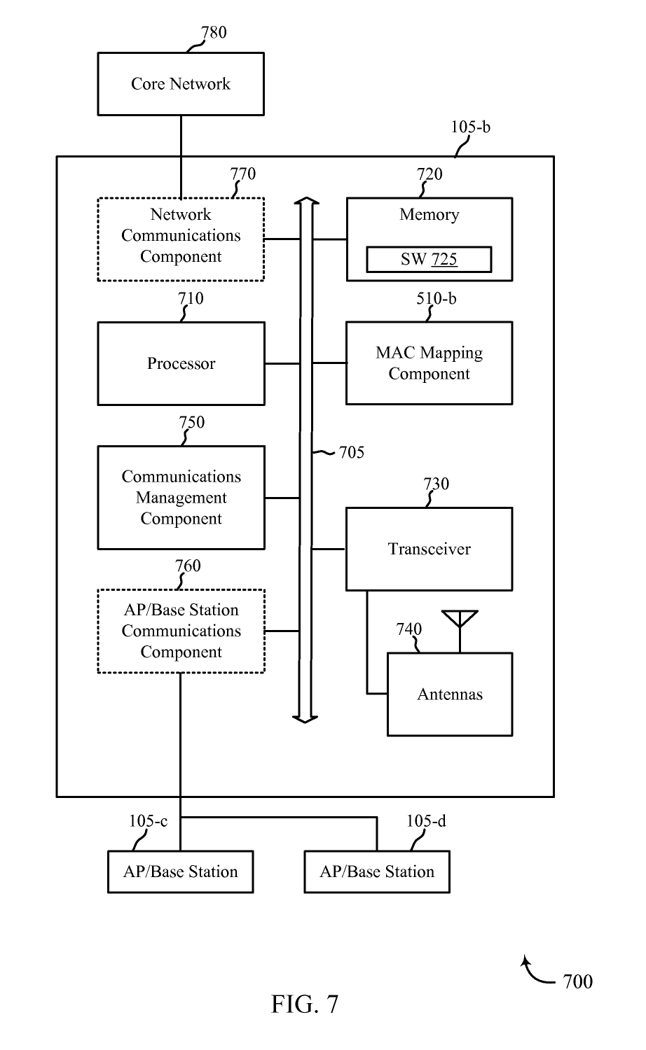

Turning to FIG. 7, a diagram 700 is shown that illustrates an AP/base station 105-b to support MAC address randomization for privacy. In some aspects, the AP/base station 105-b may be an example of the APs/base stations 105 of FIGS. 1-6. The AP/base station 105-b may include a processor 710, a memory 720, a transceiver 730, antennas 740, and a MAC mapping component 510-b. The MAC mapping component 510-b may be an example of the MAC mapping components 510 of FIG. 5 or 6. In some examples, the AP/base station 105-b may also include one or both of an AP/base station communications component 760 and a network communications component 770. Each of these components may be in communication with each other, directly or indirectly, over at least one bus 705.

The memory 720 may include RAM and ROM. The memory 720 may also store computer-readable, computer-executable software (SW) code 725 containing instructions that, when executed, cause the processor 710 to perform various functions described herein for privacy using MAC address randomization, for example. Alternatively, the software code 725 may not be directly executable by the processor 710 but cause the computer, e.g., when compiled and executed, to perform functions described herein.

The processor 710 may include an intelligent hardware device, e.g., a CPU, a microcontroller, an ASIC, etc. The processor 710 may process information received through the transceiver 730, the AP/base station communications component 760, and/or the network communications component 770. The processor 710 may also process information to be sent to the transceiver 730 for transmission through the antennas 740, to the AP/base station communications component 760, and/or to the network communications component 770. The processor 710 may handle, alone or in connection with the MAC mapping component 510-b, various aspects related to wireless transmission privacy using an OTA MAC address for wireless transmissions and a persistent MAC address for backend legacy communications.

The transceiver 730 may include a modem to modulate the packets and provide the modulated packets to the antennas 740 for transmission, and to demodulate packets received from the antennas 740. The transceiver 730 may be implemented as at least one transmitter component and at least one separate receiver component. The transceiver 730 may communicate bi-directionally, via the antennas 740, with at least one wireless station 115 as illustrated in FIGS. 1-6, for example. The AP/base station 105-b may include multiple antennas 740 (e.g., an antenna array). The AP/base station 105-b may communicate with a core network 780 through the network communications component 770. The AP/base station 105-b may communicate with other APs/base stations, such as the AP/base station 105-c and the AP/base station 105-d, using an AP/base station communications component 760.

According to the architecture of FIG. 7, the AP/base station 105-b may further include a communications management component 750. The communications management component 750 may manage communications with stations and/or other devices as illustrated in the WLAN network 100 of FIG. 1. The communications management component 750 may be in communication with some or all of the other components of the AP/base station 105-b via the bus or buses 705. Alternatively, functionality of the communications management component 750 may be implemented as a component of the transceiver 730, as a computer program product, and/or as at least one controller element of the processor 710.

The components of the AP/base station 105-b may implement aspects discussed above with respect FIGS. 1-6, and those aspects may not be repeated here for the sake of brevity.

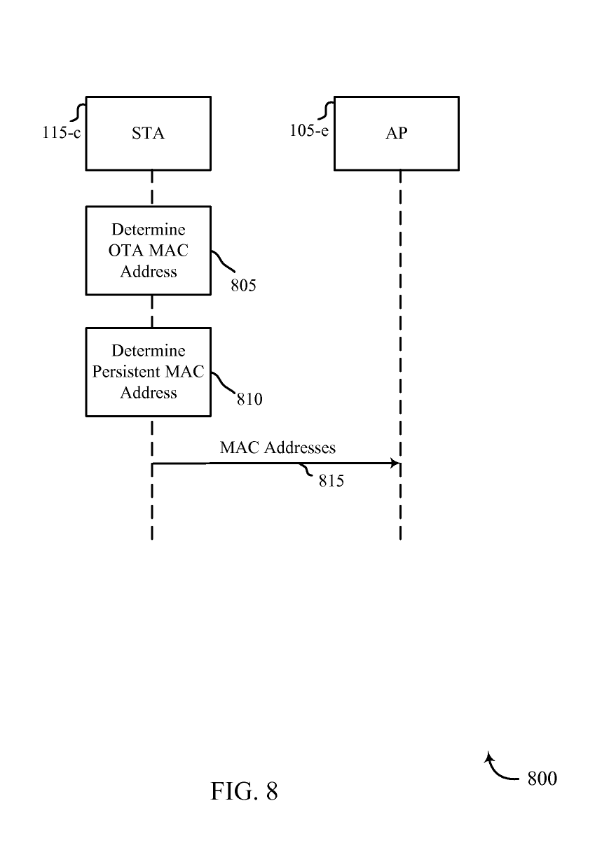

FIG. 8 is a swim lane diagram 800 illustrating aspects of wireless communication, in accordance with various aspects of the present disclosure. The diagram 800 may illustrate aspects of the WLAN network 100 described with reference to FIG. 1. The diagram 800 includes a wireless station 115-c and an access point (AP) 105-e. The wireless station 115-c may be an example of at least one of the wireless stations and/or the apparatuses 220 described above with respect to FIGS. 1-4. The access point 105-e may be an example of at least one of the access points, base stations, and/or the devices 520 described above with respect to FIGS. 1-7. The diagram 800 illustrates aspects of MAC address randomization for privacy using different MAC addresses for OTA transmissions and backend communications. In some examples, a system device, such as one of the wireless stations 115, apparatuses 220, device 520, and/or APs 105 may execute sets of codes to control the functional elements of the device to perform some or all of the functions described below.

At block 805, the wireless station 115-c may determine a MAC address for over-the-air (OTA) wireless transmissions. The OTA MAC address may be a random MAC address and, in some aspects, may be different than a permanent MAC address of the wireless station 115-c. At block 810, the wireless station 115-c may determine a second MAC address that is a persistent MAC address and used for backend communications. For example, the persistent MAC address may provide for data routing functions to/from the wireless station 115-c, for mobility tracking and management of the wireless station 115-c, to enable on-board applications to operate that use a MAC address for authentication, association, and/or other functions, etc. In some examples, the persistent MAC address may be the permanent MAC address of the wireless station 115-c.

At 815, the wireless station 115-c may send, transmit, or otherwise communicate the OTA MAC address and the persistent MAC address, or information indicative of such addresses, to the access point 105-e. In some aspects, the wireless station 115-c may communicate the information during a security association process, e.g., when the wireless station 115-c first associates and registers with the access point 105-e. The information may be communicated via a secure channel and/or encrypted. In some examples, the security association process may be a 4-way handshake procedure where the wireless station 115-c may communicate the information in message 4 of the procedure. In another example, the security association process may be a 2-way handshake procedure where the wireless station 115-c communicates the information in a message 1 or a message 2.

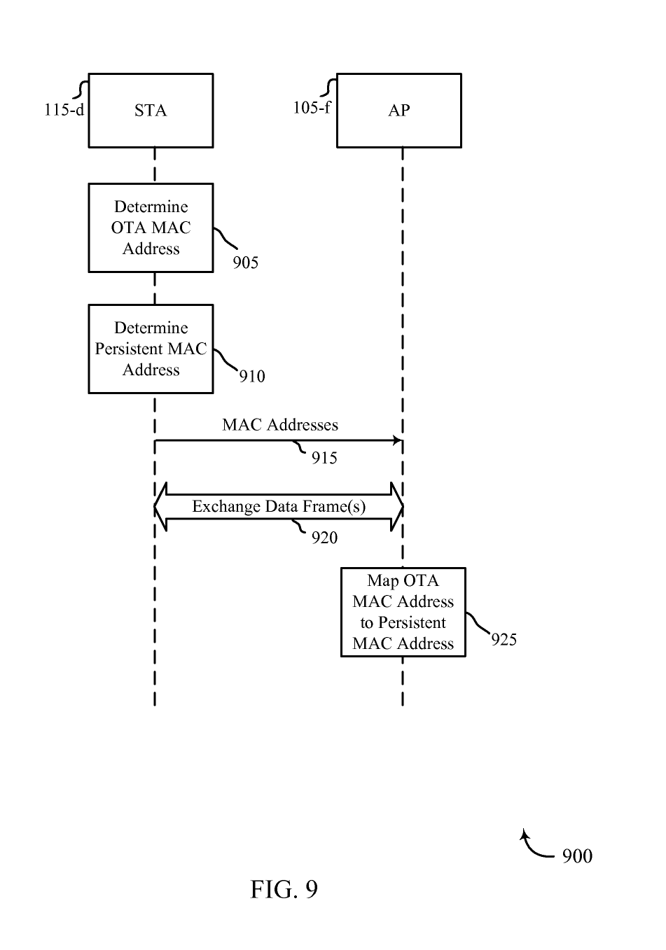

FIG. 9 is a swim lane diagram 900 illustrating aspects of wireless communication, in accordance with various aspects of the present disclosure. The diagram 900 may illustrate aspects of the WLAN network 100 described with reference to FIG. 1. The diagram 900 includes a wireless station 115-d and an access point 105-f. The wireless station 115-d may be an example of at least one of the wireless stations and/or the apparatuses 220 described above with respect to FIGS. 1-4. The access point 105-f may be an example of at least one of the access points, base stations, and/or the devices 520 described above with respect to FIGS. 1-7. The diagram 900 illustrates aspects of MAC address randomization for privacy using different MAC addresses for OTA transmissions and backend communications. In some examples, a system device, such as one of the wireless stations 115, apparatuses 220, device 520, 520-a, and/or APs 105 may execute sets of codes to control the functional elements of the device to perform some or all of the functions described below.

At block 905, the wireless station 115-d may determine a MAC address for over-the-air wireless transmissions. The OTA MAC address may be a random MAC address and/or, in some aspects, may be different than a permanent MAC address of the wireless station 115-c. At block 910, the wireless station 115-d may determine a second MAC address that is a persistent MAC address and/or used for backend communications. For example, the persistent MAC address may provide for data routing functions to/from the wireless station 115-d, for mobility tracking and management of the wireless station 115-d, to enable on-board applications to operate that use a MAC address for authentication, association, and/or other functions, etc.

At 915, the wireless station 115-d may send, transmit, or otherwise communicate the OTA MAC address and the persistent MAC address, or information indicative of such addresses, to the access point 105-f via a secure channel. In some aspects, the wireless station 115-d may communicate the information during a security association process, e.g., when the wireless station 115-d first associates and registers with the access point 105-e. At 920, the wireless station 115-d and the access point 105-f may exchange data frame(s). The data frames may be wirelessly transmitted between the wireless station 115-d and the access point 105-f and may include the OTA MAC address. That is, the OTA MAC address may be used to route the wireless transmissions of the data frames from the wireless station 115-d to the access point 105-f, and vice versa.

At block 925, the access point 105-f may map the OTA MAC address to the persistent MAC address. For wireless station 115-d originated data frames, the access point 105-f may map the OTA MAC address to the persistent MAC address and forward the data frames to legacy network entities using the persistent MAC address. For remote originated data frames, the access point 105-f may map the persistent MAC address to the OTA MAC address and transmit the data frames to the wireless station 115-d using the OTA MAC address.

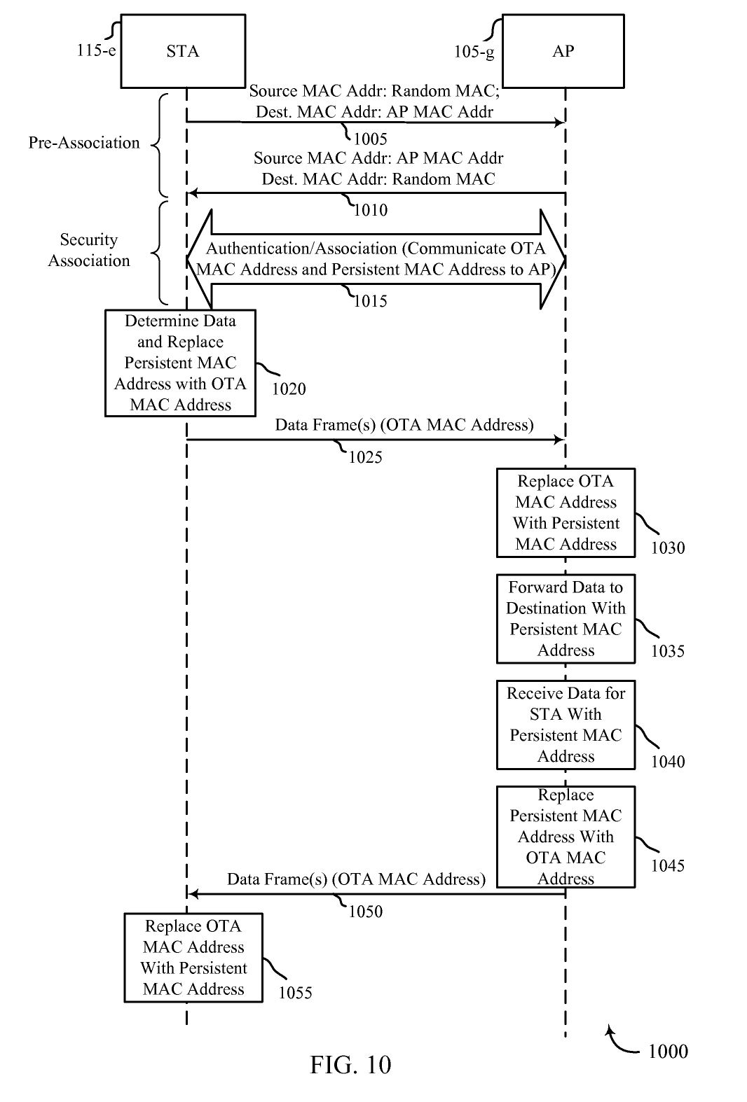

FIG. 10 is a swim lane diagram 1000 illustrating aspects of wireless communication, in accordance with various aspects of the present disclosure. The diagram 1000 may illustrate aspects of the WLAN network 100 described with reference to FIG. 1. The diagram 1000 includes a wireless station 115-e and an access point 105-g. The wireless station 115-e may be an example of at least one of the wireless stations and/or the apparatuses 220 described above with respect to FIGS. 1-4. The access point 105-g may be an example of at least one of the access points and/or the devices 520 described above with respect to FIGS. 1-7. The diagram 1000 illustrates aspects of MAC address randomization for privacy using different MAC addresses for OTA transmissions and backend communications. In some examples, a system device, such as one of the wireless stations/apparatuses 220 and/or device 520/APs 105 may execute sets of codes to control the functional elements of the device to perform some or all of the functions described below.

At 1005, wireless station 115-e may send a probe request to the access point 105-g during a pre-association process. During the pre-association process, i.e., before the wireless station 115-e and the access point 105-g are associated with each other, the wireless station 115-e may generate a random MAC address and include the random MAC address as a source address in a MAC header of the probe request frame. At 1010, upon receipt of the probe request, the access point 105-g may send a probe response to the wireless station 115-e. The access point 105-g may use its AP MAC address as a source address in a MAC header of the probe response frame and the random MAC address received in the probe request frame as a destination address in the MAC header. At 1015, the wireless station 115-e and the access point 105-g may perform a security association process where the wireless station 115-e authenticates with the access point 105-g. The security association may include the wireless station 115-e communicating an OTA MAC address and a persistent MAC address to the access point 105-g via a secure channel. The OTA MAC address may be used for wireless transmissions between the wireless station 115-e and the access point 105-g and may provide for privacy of the identity of the wireless station 115-e from eavesdroppers. The OTA MAC address and/or the persistent MAC address may be determined by the wireless station 115-e, by the access point 105-g, and/or by negotiations during the security association process.

At block 1020, the wireless station 115-e may determine it has data to be communicated and replace the persistent MAC address with the OTA MAC address. At 1025, the wireless station 115-e may transmit the data frames to the access point 105-g using the OTA MAC address. At 1030, the access point 105-g may replace the OTA MAC address with the persistent MAC address and forward the data frames with the persistent address at 1035. Accordingly, the wireless station 115-e may wirelessly transmit the data frames using the OTA MAC address and avoid disclosing identifying information to an attacker snooping the wireless transmissions.

At block 1040, the access point 105-g may receive data addressed to the wireless station 115-e. The data may include or be routed based on the persistent MAC address of the wireless station 115-e. At 1045, the access point 105-g may replace the persistent MAC address with the OTA MAC address and send the data frames to the wireless station 115-e at 1050 and using the OTA MAC address. At block 1055, the wireless station 115-e may replace the OTA MAC address with the persistent MAC address and process the data frames, e.g., decode the data frames.

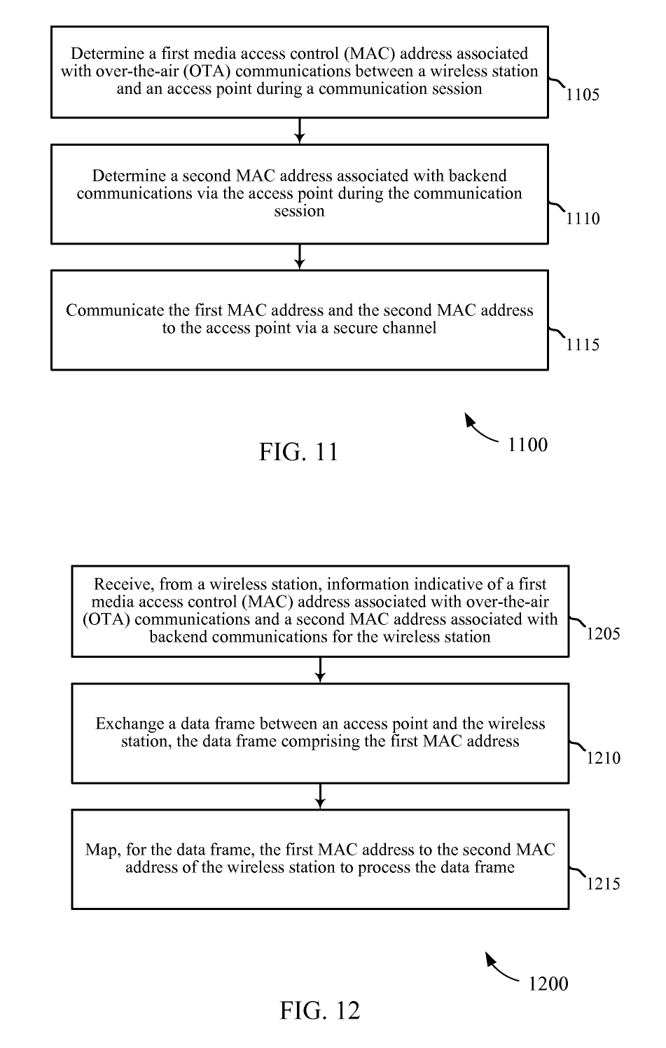

FIG. 11 is a flow chart illustrating an example of a method 1100 for wireless communication, in accordance with various aspects of the present disclosure. For clarity, the method 1100 is described below with reference to aspects of the wireless stations described with reference to FIGS. 1 and 5-10, and/or aspects of the apparatuses described with reference to FIGS. 2-4. In some examples, a wireless station may execute sets of codes to control the functional elements of the wireless station to perform the functions described below. Additionally or alternatively, the wireless station may perform the functions described below using-purpose hardware.

At block 1105, the method 1100 may include determining a first MAC address associated with OTA communications between a wireless station and an access point during a communication session. In some examples, the wireless station may randomly select the OTA MAC address. At block 1110, the method 1100 may include determining a second MAC address associated with backend communications via the access point during the communication session. The second MAC address may be a persistent MAC address and, in some examples, be the permanently assigned MAC address of the wireless station. At block 1115, the method 1100 may include communicating the first and second MAC addresses to the access point. The MAC addresses, or information indicative thereof, may be communicated during a security association process via a secure channel.

The operation(s) at blocks 1105, 1110, and 1115 may be performed using the MAC privacy component 210, 425 described with reference to FIGS. 2-4.

Thus, the method 1100 may provide for wireless communication. It should be noted that the method 1100 is just one implementation and that the operations of the method 1100 may be rearranged or otherwise modified such that other implementations are possible.

FIG. 12 is a flow chart illustrating an example of a method 1200 for wireless communication, in accordance with various aspects of the present disclosure. For clarity, the method 1200 is described below with reference to aspects of the access points described with reference to FIGS. 1-4 and 8-10, and/or aspects of the devices described with reference to FIGS. 5-7. In some examples, an access point may execute sets of codes to control the functional elements of the access point to perform the functions described below. Additionally or alternatively, the access point may perform the functions described below using-purpose hardware.

At block 1205, the method 1200 may include receiving information indicative of a first MAC address associated with OTA communications and a second MAC address associated with backend communications via the access point. The second MAC address may be a persistent MAC address of the wireless station and, in some examples, be the permanently assigned MAC address of the wireless station. At block 1210, the method 1200 may include exchanging a data frame between the access point and the wireless station. The data frame may include the OTA MAC address. At block 1215, the method 1200 may include mapping, for the data frame, the first MAC address to the second MAC address to process the data frame. The access point may access a look-up table to map the first MAC address to the second MAC address, for example.

The operation(s) at blocks 1205, 1210, and 1215 may be performed using the MAC mapping component 510 described with reference to FIGS. 5-7.

Thus, the method 1200 may provide for wireless communication. It should be noted that the method 1200 is just one implementation and that the operations of the method 1200 may be rearranged or otherwise modified such that other implementations are possible.

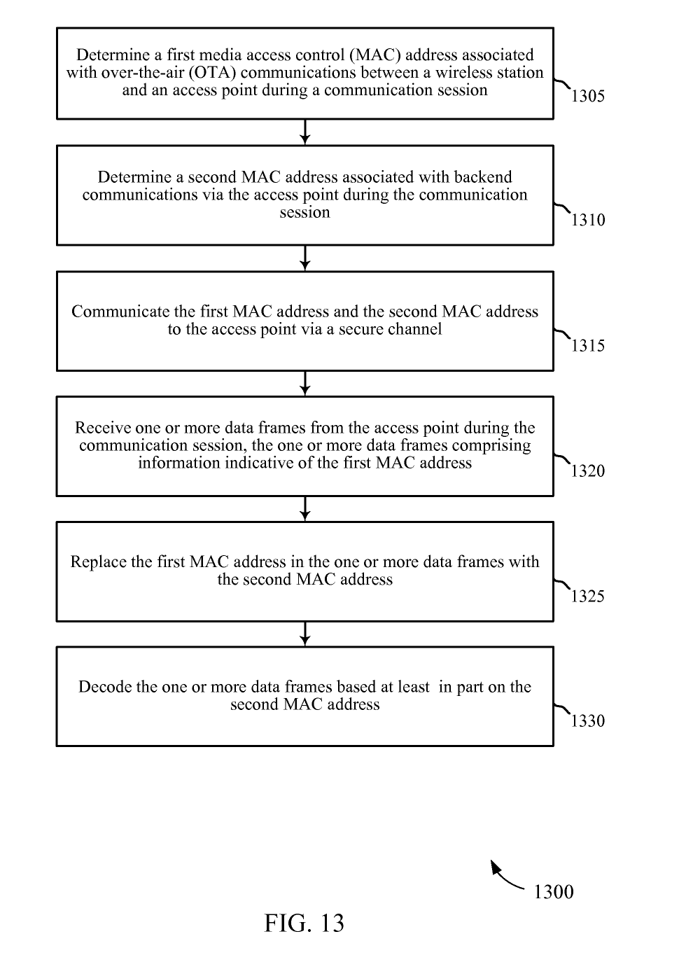

FIG. 13 is a flow chart illustrating an example of a method 1300 for wireless communication, in accordance with various aspects of the present disclosure. For clarity, the method 1300 is described below with reference to aspects of the wireless stations described with reference to FIGS. 1, and 5-10, and/or aspects of the apparatuses described with reference to FIGS. 2-4. In some examples, a wireless station may execute sets of codes to control the functional elements of the wireless station to perform the functions described below. Additionally or alternatively, the wireless station may perform the functions described below using-purpose hardware.

At block 1305, the method 1300 may include determining a first MAC address associated with OTA communications between a wireless station and an access point during a communication session. In some examples, the wireless station may randomly select the OTA MAC address. At block 1310, the method 1300 may include determining a second MAC address associated with backend communications via the access point during the communication session. The second MAC address may be a persistent MAC address and, in some examples, be the permanently assigned MAC address of the wireless station. At block 1315, the method 1300 may include communicating the first and second MAC addresses to the access point. The MAC addresses, or information indicative thereof, may be communicated during a security association process.

At block 1320, the method 1300 may include receiving data frame(s) from the access point that includes the first MAC address. That is, the data frames may be wirelessly transmitted using the first MAC address. At block 1325, the method 1300 may include replacing the first MAC address with the second MAC address. At block 1330, the wireless station may decode the data frame(s) based on the second MAC address.

The operation(s) at blocks 1305, 1310, 1315, 1320, 1325, and 1330 may be performed using the MAC privacy component 210, 425 described with reference to FIGS. 2-4.

Thus, the method 1300 may provide for wireless communication. It should be noted that the method 1300 is just one implementation and that the operations of the method 1300 may be rearranged or otherwise modified such that other implementations are possible.

In some examples, aspects from two or more of the methods 1100, 1200, and/or 1300 may be combined. It should be noted that the methods 1100-1300 are just example implementations, and that the operations of the methods 1100-1300 may be rearranged or otherwise modified such that other implementations are possible.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, electrically erasable programmable ROM (EEPROM), flash memory, compact disk (CD)-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Throughout this disclosure the term “example” or “exemplary” indicates an example or instance and does not imply or require any preference for the noted example. Thus, the disclosure is not to be limited to the examples and designs described herein but is to be accorded the broadest scope consistent with the principles and novel features disclosed herein.

What is claimed is:

1. A method for wireless communication at a wireless station, comprising:
determining a first media access control (MAC) address associated with over-the-air (OTA) communications between the wireless station and an access point during a communication session;
determining a second MAC address associated with backend communications via the access point during the communication session; and
communicating the first MAC address and the second MAC address to the access point via a secure channel.

2. The method of claim 1, further comprising:
generating a random MAC address, the random MAC address comprising a third MAC address, wherein the third MAC address is used as a source address prior to communicating the first MAC address and the second MAC address to the access point via the secure channel.

3. The method of claim 1, further comprising:
generating a random MAC address, the random MAC address comprising the first MAC address; and
transmitting at least one message to the access point comprising the random MAC address via the secure channel.

4. The method of claim 1, further comprising:
performing, with the access point, a security association process to establish the secure channel.

5. The method of claim 4, further comprising:
transmitting information indicative of the first MAC address and the second MAC address to the access point in a message 4 of the security association process, wherein the security association process is a 4-way handshake procedure, wherein the first MAC address and the second MAC address are encrypted.

6. The method of claim 4, further comprising:
transmitting information indicative of the first MAC address and the second MAC address to the access point in a message 1 of the security association process, wherein the security association process is a 2-way handshake procedure.

7. The method of claim 1, further comprising:
receiving a data frame from the access point during the communication session, the data frame comprising information indicative of the first MAC address;
replacing the first MAC address in the data frame with the second MAC address; and
decoding the data frame based at least in part on the second MAC address.

8. The method of claim 1, further comprising:
identifying a data frame to be transmitted to the access point during the communication session, the data frame comprising information indicative of the second MAC address;
replacing the second MAC address in the data frame with the first MAC address; and
transmitting the data frame to the access point using the first MAC address as a source address.

9. The method of claim 1, further comprising:
receiving a data frame from the access point during the communication session, the data frame comprising a MAC frame having the second MAC address as a destination address being encapsulated with a MAC frame header having the first MAC address as a destination address;
removing the MAC frame encapsulating the second MAC address; and
decoding the data frame based at least in part on the second MAC address.

10. The method of claim 1, further comprising:
identifying a data frame to be transmitted to the access point during the communication session;
encapsulating a MAC frame having the second MAC address as a destination address using a MAC frame header having the first MAC address as a destination address; and
transmitting the data frame to the access point, the data frame comprising the encapsulated MAC frame.

11. The method of claim 1, wherein the second MAC address is valid for the communication session.

12. The method of claim 11, further comprising:
deriving the second MAC address based at least in part on a pairwise master key known by the wireless station and the access point.

13. The method of claim 1, wherein the first MAC address is valid for the communication session.

14. The method of claim 1, further comprising:
changing the first MAC address during the communication session based at least in part on a pairwise master key known by both the wireless station and the access point.

15. The method of claim 1, wherein the second MAC address is a permanent MAC address of the wireless station.

16. An apparatus for wireless communication, comprising:
a processor;
memory in electronic communication with the processor; and
instructions being stored in the memory, the instructions being executable by the processor to:
determine a first media access control (MAC) address associated with over-the-air (OTA) communications between a wireless station and an access point during a communication session;
determine a second MAC address associated with backend communications via the access point during the communication session; and
communicate the first MAC address and the second MAC address to the access point via a secure channel.

17. The apparatus of claim 16, further comprising instructions executable by the processor to:
generate a random MAC address, the random MAC address comprising a third MAC address, wherein the randomly generated third MAC address is used as a source address prior to communicating the first MAC address and the second MAC address to the access point via the secure channel.

18. The apparatus of claim 16, further comprising instructions executable by the processor to:
generate a random MAC address, the random MAC address comprising the first MAC address; and
transmit at least one message to the access point comprising the random MAC address via the secure channel.

19. The apparatus of claim 16, further comprising instructions executable by the processor to:
perform, with the access point, a security association process to establish the secure channel.

20. The apparatus of claim 19, further comprising instructions executable by the processor to:
transmit information indicative of the first MAC address and the second MAC address to the access point in a message 4 of the security association process, wherein the security association process is a 4-way handshake procedure, wherein the first MAC address and the second MAC address are encrypted.

21. The apparatus of claim 16, further comprising instructions executable by the processor to:
receive a data frame from the access point during the communication session, the data frame comprising information indicative of the first MAC address;
replace the first MAC address in the data frame with the second MAC address; and
decode the data frame based at least in part on the second MAC address.

22. The apparatus of claim 16, further comprising instructions executable by the processor to:
identify a data frame to be transmitted to the access point during the communication session, the data frame comprising information indicative of the second MAC address;
replace the second MAC address in the data frame with the first MAC address; and
transmit the data frame to the access point using the first MAC address as a source address.

23. The apparatus of claim 16, further comprising instructions executable by the processor to:
receive a data frame from the access point during the communication session, the data frame comprising a MAC frame having the second MAC address as a destination address being encapsulated with a MAC frame header having the first MAC address as a destination address;
remove the MAC frame encapsulating the second MAC address; and
decode the data frame based at least in part on the second MAC address.

24. The apparatus of claim 16, further comprising instructions executable by the processor to:
identify a data frame to be transmitted to the access point during the communication session;
encapsulate a MAC frame having the second MAC address as a destination address using a MAC frame header having the first MAC address as a destination address; and
transmit the data frame to the access point, the data frame comprising the encapsulated MAC frame.

25. A method for wireless communication at an access point, comprising:
receiving, from a wireless station, information indicative of a first media access control (MAC) address associated with over-the-air (OTA) communications and a second MAC address associated with backend communications for the wireless station;
exchanging a data frame between the access point and the wireless station, the data frame comprising the first MAC address; and
mapping, for the data frame, the first MAC address to the second MAC address of the wireless station to process the data frame.

26. The method of claim 25, further comprising:
performing backend communications for the data frame based at least in part on the second MAC address.

27. The method of claim 25, further comprising:
constructing a look-up table to map the first MAC address to the second MAC address or map the second MAC address to the first MAC address.

28. The method of claim 25, wherein mapping the first MAC address to the second MAC address comprises:
referencing a look-up table to identify the second MAC address that corresponds to the first MAC address; and
replacing the first MAC address with the second MAC address in the data frame.

29. The method of claim 25, wherein mapping the first MAC address to the second MAC address comprises:
referencing a look-up table to identify the second MAC address that corresponds to the first MAC address;
removing a MAC frame header with a destination address of the first MAC address from the data frame to reveal a MAC frame with a destination address of the second MAC address.

30. An apparatus for wireless communication, comprising:
a processor;
memory in electronic communication with the processor; and
instructions being stored in the memory, the instructions being executable by the processor to:
receive, from a wireless station, information indicative of a first media access control (MAC) address associated with over-the-air (OTA) communications and a second MAC address associated with backend communications for the wireless station;
exchange a data frame between an access point and the wireless station, the data frame comprising the first MAC address; and
map, for the data frame, the first MAC address to the second MAC address of the wireless station to process the data frame.
